(19) United States
(12) Patent Application Publication
(10) Pub. No.: US 2026/0270088 A1
(43) Pub. Date: Sep. 10, 2026

(54) Verification of Data of an Authentication and Key-Agreement Protocol Process

(71) Applicant: Siemens Aktiengesellschaft, München (DE)

(72) Inventors: Rainer Falk, München (DE); Hans Aschauer, München (DE); Kai Che, München (DE); Fabrizio De Santis, München (DE); Andreas Fuch, München (DE); Malek Safieh, München (DE); Daniel Schneider, München (DE); Antonio Vaira, München (DE); Thomas Zeschg, München (DE); Johannes Zwanzger, München (DE)

(73) Assignee: Siemens Aktiengesellschaft, München (DE)

(21) Appl. No.: 19/165,931

(22) PCT Filed: Mar. 12, 2024
(86) PCT No.: PCT/EP2024/056545

§ 371 Date: Sep. 16, 2025

(30) Foreign Application Priority Data
Mar. 20, 2023 (EP) 23162899.1

(51) Int. Cl. H04L 9/32; H04L 9/08; H04L 9/14

(52) U.S. Cl. CPC H04L 9/3249; H04L 9/0844; H04L 9/0852; H04L 9/0891; H04L 9/14

(57) ABSTRACT

Various embodiments of the teachings herein include a verification unit. An example includes: a capture unit to capture an authentication and key agreement protocol sequence; a generation unit to derive data associated with the sequence from the sequence by including a notarization guideline; and an authentication unit to protect the integrity of the data by forming integrity-protected data. The authentication unit comprises a signature unit to deliver the integrity-protected data in signed form using: a post-quantum secure signature method or a post-quantum secure key encapsulation mechanism or a classical cryptographic digital signature method. The system includes a delivery unit to deliver the integrity-protected data.

### CROSS-REFERENCE TO RELATED APPLICATIONS

This application is a U.S. National Stage Application of International Application No. PCT/EP2024/056545 filed Mar. 12, 2024, which designates the United States of America, and claims priority to EP Application Serial No. 23162899.1 filed Mar. 20, 2023, the contents of which are hereby incorporated by reference in their entirety.

### TECHNICAL FIELD

The present disclosure relates to data verification. Various embodiments of the teachings herein include verification units and methods for delivering integrity-protected data.

### BACKGROUND

Protocols such as TLS, DTLS, QUIC, or IPsec/IKEv2 can be used for cryptographically protected communication between two subscribers. This is accomplished first by carrying out an authentication and key agreement (AKA), in which the subscribers authenticate themselves to one another (mutual authentication) or authenticate themselves at least unilaterally (unilateral authentication). Furthermore, an unauthenticated key agreement is also possible, even if this is more likely to be relevant in special cases in practice. Authentication and key agreement involves symmetrical key material (session keys) being arranged that is used for cryptographic protection (encryption, integrity protection and/or authenticated encryption) of transmitted user data between subscribers.

In conventional cryptographic methods such as RSA or elliptic curves, authentication is normally accomplished using a digital signature, which is used to digitally sign AKA protocol messages or AKA parameters included therein. In the case of customary post-quantum (PQ) cryptographic algorithms (or, in general, next generation crypto algorithms), signature computation is computationally complex. For that reason, an authentication based on KEM (Key Encapsulation Mechanism) has been proposed, e.g. using KEMTLS. However, both variants involve a subscriber being authenticated only once, i.e. using a single cryptographic method and a corresponding authentication credential (private key and related digital certificate) for this method.

Some recommendations for utilizing post-quantum cryptographic algorithms, e.g. from the Bundesamt für Sicherheit in der Informationstechnik (BSI) or from the Agence nationale de la sécurité des systèmes d′information (ANSSI), call for basically hybrid cryptographic methods in which a PQ algorithm is used together with a conventional algorithm. Cf. BSI: Migration to Post Quantum Cryptography, Recommendations for action by the BSI, 05.31.2021, section 3.5: “Therefore, the BSI does not recommend using post-quantum cryptography alone, but only “hybrid” if possible, i.e. in combination with classical algorithms. In a hybrid key exchange, for example, the two negotiated secrets must be combined by means of a suitable key derivation function to form a session key. In high-security applications, the BSI requires the use of hybrid solutions.” The combination is supposed to be secure insofar as at least one of the cryptographic algorithms used is not broken (e.g. by a quantum computer or as a result of an algorithmic design weakness or as a result of an implementation problem).

An overview of PQ cryptography is provided by BSI, Quantum-safe cryptography—fundamentals, current developments and recommendations, October 2021. Section 3.1.1 therein, “Key agreement”, describes a hybrid key agreement, and section 3.1.2, “Hybrid signatures and adaptation of public key infrastructures”, describes a multiple signature of a message (message authentication).

Within an authentication and key agreement protocol sequence between two nodes, hybrid key agreement protocols involve two cryptographically different key agreements being carried out, each of which results in a session key, these session keys then being used to form an overall session key to protect transmitted user data. The design and implementation of hybrid authentication methods that involve two different cryptographic authentication algorithms being combined is complex, however, and cannot simply be transposed broadly for different security protocols and different cryptographic algorithms.

### SUMMARY

The teachings of the present disclosure provide solutions for improved between authenticity protection for communication subscribers. For example, some embodiments of the teachings herein include a verification unit (2), comprising: a capture unit (21), designed to capture an authentication and key agreement protocol sequence, a generation unit (22), designed to derive data associated with the authentication and key agreement protocol sequence from the authentication and key agreement protocol sequence by including a notarization guideline (211), an authentication unit (23), designed to protect the integrity of the data, thereby forming integrity-protected data (232), the authentication unit (23) being in the form of a signature unit (23), the signature unit (23) being designed to deliver the integrity-protected data (232) in signed form, the signature unit (23) being designed to protect the integrity of the data by means of: a post-quantum secure signature method or a post-quantum secure key encapsulation mechanism or a classical cryptographic digital signature method, thereby delivering the integrity-protected data (232) in the signed form and/or in integrity-protected form and a delivery unit (24), designed to deliver the integrity-protected data (232).

In some embodiments, the data comprises: at least one message (2321a, 2321b, 2321c, 2321d) that was exchanged within the authentication and key agreement protocol sequence, a message part of a message (2321a, 2321b, 2321c, 2321d) that was exchanged within the authentication and key agreement protocol sequence, a control message (2321a, 2321b, 2321c, 2321d) in an industrial automation system that was exchanged within the authentication and key agreement protocol sequence, and/or a cryptographic hash value of a message (2321a, 2321b, 2321c, 2321d) that was exchanged within the authentication and key agreement protocol sequence.

In some embodiments, the data comprises a parameter (2325a, 2325b) of an authentication and key agreement (121) associated with the authentication and key agreement protocol sequence, the parameter (2325a, 2325b) being in the form of: an authentication credential (1211) of the authentication and key agreement (121) associated with the authentication and key agreement protocol sequence, information about a communication partner of the authentication and key agreement protocol sequence, an identifier ID of a communication partner of the authentication and key agreement protocol sequence, and/or user data of a communication partner of the authentication and key agreement protocol sequence.

In some embodiments, the verification unit (2) includes a transmission unit (24), designed to transmit the integrity-protected data (232).

In some embodiments, the verification unit (2) includes an encryption unit, designed to deliver the integrity-protected data (232) in encrypted form.

In some embodiments, the authentication and key agreement (121) associated with the authentication and key agreement protocol sequence entails: a classical cryptographic algorithm, in particular pertaining to a Diffie-Hellman key exchange or an elliptic curve Diffie-Hellman key exchange, a classical cryptographic authentication method, in particular RSA signature, DSA, ECDSA, a post-quantum secure cryptographic method, in particular a lattice- or code-based key encapsulation mechanism, in particular Kyber, FrodoKEM or Classic McEliece, or a hybrid method, consisting of a classical cryptographic algorithm and a post-quantum secure cryptographic method.

In some embodiments, the notarization guideline (211) defining a stipulation under which the generation unit is designed to derive the data, the stipulation relating to: a security protocol (12), an authentication and key agreement method and/or an authentication credential (1211), each pertaining to the authentication and key agreement (121) associated with the authentication and key agreement protocol sequence.

In some embodiments, the notarization guideline (211) defining a condition under which the generation unit (22) is designed to derive the data, the condition comprising: connection setup, update of a session key (1212) within a connection that has already been set up, and/or resumption of a previously existing connection, each as part of the authentication and key agreement protocol sequence.

As another example, some embodiments include a device (1) comprising a verification unit (2) as described herein.

In some embodiments, the device (1) includes an agreement unit, designed to perform an authentication and key agreement (121), thereby generating a session key (1212), and a communication unit (13), designed to utilize the session key (1212) in the authentication and key agreement protocol sequence to protect communication.

As another example, some embodiments include a method for delivering integrity-protected data (232), comprising: capturing an authentication and key agreement protocol sequence, deriving data from the authentication and key agreement protocol sequence by including a notarization guideline (211), the data being associated with the authentication and key agreement protocol sequence, protecting the integrity of the data, thereby forming integrity-protected data (232), and delivering the integrity-protected data (232).

In some embodiments, the method includes: performing an authentication and key agreement, thereby generating a session key (1212), and communicating within the authentication and key agreement protocol sequence by utilizing the session key (1212) to protect the communication.

In some embodiments, the method includes checking the integrity-protected data (232).

### BRIEF DESCRIPTION OF THE DRAWINGS

The features and advantages of the teachings herein are apparent from the explanations of multiple exemplary embodiments that follow with reference to the schematic drawings. In the drawings:

FIG. 1 shows a device according to the prior art;

FIG. 2 shows a verification unit incorporating teachings of the present disclosure as an additional component for the device;

FIG. 3 shows a schematic representation of integrity-protected data associated with the authentication and key agreement protocol sequence (AKA verification) incorporating teachings of the present disclosure; and

FIG. 4 shows a schematic representation of an evaluated AKA verification incorporating teachings of the present disclosure.

### DETAILED DESCRIPTION

The present disclosure relates to verification units. An example includes:
a capture unit, designed to capture an authentication and key agreement protocol sequence,
a generation unit, designed to derive data associated with the authentication and key agreement protocol sequence from the authentication and key agreement protocol sequence by including a notarization guideline,
an authentication unit, designed to protect the integrity of the data, thereby forming integrity-protected data, and
a delivery unit, designed to deliver the integrity-protected data.

The verification unit is designed to derive a verification of data that are associated with an authentication and key agreement protocol sequence and to deliver said verification in integrity-protected, in particular signed, form. The integrity-protected data can also be referred to as verified data. In general, the authentication and key agreement protocol sequence is a communication session, a communication connection, and/or a data transmission.

An authentication and key agreement generates a session key. The authentication and key agreement is known as AKA. The generated session key is designed to protect data that are interchanged in a communication protocol sequence, the authentication and key agreement protocol sequence. Thus, the previously generated session key is used in the authentication and key agreement protocol sequence (AKA sequence) to protect the communication protocol that is being executed, in particular the messages exchanged during execution. The exchanged messages are an embodiment of data that are associated with the authentication and key agreement protocol sequence.

In particular, the authentication and key agreement may be used to arrange a symmetric session key between two subscribers (a first and a second subscriber). The symmetric session key is used to cryptographically protect transmitted between the subscribers (e.g. IPsec, TLS Record Layer, IEEE 802.1AE). The authentication and key agreement is authenticated by means of a first authentication credential (which can also be referred to as the private key) of the first subscriber by means of a first cryptographic algorithm related to the first authentication credential (or, in general, a first authentication method). Optionally (mutually, mutual authentication), the authentication and key agreement can additionally be authenticated by means of a second authentication credential (private key) of the second subscriber by means of a second cryptographic algorithm related to the second authentication credential (or, in general, a second authentication method).

Normally, the first cryptographic algorithm and the second cryptographic algorithm are identical, i.e. the first subscriber and the second subscriber use the same cryptographic algorithm to authenticate themselves each time (e.g. RSA (classical), ECC (classical), KEM (classical or PQ)).

The verification unit can also be referred to as the AKA notarization module, the AKA verification system and/or the AKA verification unit. The integrity-protected data can also be referred to as the AKA verification. The data associated with the authentication and key agreement protocol sequence can also be referred to as a data structure; for the purposes of the disclosure, they can be regarded in particular as an “as yet unsigned AKA verification data structure”. In particular, the feature that the data are “associated” with the authentication and key agreement protocol sequence is intended to be understood to mean that the data result from an authentication and key agreement protocol that is being executed or from the (preceding, associated) authentication and key agreement. In general, the data comprise in particular information to be verified about the authentication and key agreement protocol sequence.

The notarization guideline can also be referred to as an AKA notarization policy. In particular, it also comprises multiple guidelines.

The authentication unit is designed to protect the data in respect of the integrity thereof, thereby forming integrity-protected data. The authentication unit is thus designed to perform a further authentication. The further authentication produces integrity protection for the aforementioned key authentication and agreement. The aforementioned authentication and key agreement is also called the preceding authentication and key agreement below.

A further authentication (which can also be referred to as a notarization and/or a verification) of the preceding authentication and key agreement is thus additionally carried out, in particular using a third credential (authentication credential (private key)). The third credential is different from the first authentication credential and from the possibly available second authentication credential. Furthermore, a third cryptographic algorithm (or, in general, a third authentication method) is used, which is different from the first cryptographic algorithm and from the second cryptographic algorithm. This inventive further authentication is delivered in the form of the integrity-protected data and can also be referred to as the AKA verification, since it additionally confirms the preceding authentication and key agreement again even though said authentication and key agreement has already been authenticated by means of the first and possibly the second authentication credential and by means of the first and possibly the second cryptographic algorithm.

The delivery unit of the verification unit is in particular integrated in or identical to the authentication unit.

The previous focus of research work relating to post-quantum secure security protocols has primarily been a hybrid key agreement, but not in respect of authentication. The reason for this is that the confidentiality of a communication session can also be subsequently broken if logged protocol messages are decrypted at a later time.

In general, however, PQ crypto algorithms or, in general, next-generation crypto algorithms are not accorded the same confidence as conventional crypto algorithms (RSA, ECC), which have been the subject of intensive examination over many years. It therefore seems appropriate to use multiple authentication methods in combination even for an authentication. This may be appropriate in particular for particularly critical operations such as a certificate issue using a secure communication channel (EST, SCEP) or for an onboarding process or for online banking.

Hybrid key agreement protocols are known. However, these address a hybrid key agreement but not a hybrid multiple authentication for an authentication and key agreement (AKA).

The teachings of the present disclosure provide protection that allows a conventional, non-PQ-secure further authentication to be feasibly added as an add-on system to an otherwise invariable industrial automation system. In particular if old devices or 3rd-party components cannot be updated or cannot be updated promptly so that they themselves support PQ crypto algorithms, this can result in PQ-secure additional protection being implemented subsequently.

This can also be understood as a PQ-secure overlay that can feasibly be retrofitted as additional protection in brownfield environments. This offers a solution for feasibly providable additional protection in order to be able to subsequently add a PQ-secure authentication to existing implementations and systems for secure, authenticated communication. It is admittedly sufficient only for PQ-secure authentication and integrity, not for PQ-secure long-term confidentiality protection. Such protection requirements exist for example for the transmission of control commands and measurement data in industrial control systems.

Furthermore, hybrid additional protection can therefore be provided, which is required in Europe by the BSI and the ANSSI. That is to say that if implementations meet only the current US requirements but not the European requirements, hybrid protection required for Europe can feasibly be added as an add-on.

Furthermore, a general, abstract construct that involves a preceding authentication and key agreement being protected with further, cryptographically different protection is described, thus a generic basic construct for hybrid authentication for an authentication and key agreement.

In some embodiments, the authentication unit is in the form of a signature unit, the signature unit being designed to deliver the integrity-protected data in signed form. The integrity-protected data are thus in the form of signed data. The integrity-protected data in signed form comprise in particular a PQ-secure digital signature or are protected by a PQ-secure KEM mechanism. That is to say that the preceding authentication and key agreement is verified in particular by utilizing a PQ-secure digital signature method or by utilizing a PQ-secure KEM mechanism. In particular a classical crypto method is used for the preceding authentication and key agreement, on the other hand, in particular RSA signature, DSA, ECDSA. Post-quantum secure cryptographic methods, which can also be referred to as next-generation cryptographic methods, are in particular CRYSTALS Dilithium, FALCON, SPHINCS+, LMS, XMSS and lattice- or code-based key encapsulation mechanisms (KEM), in particular Kyber, FrodoKEM or Classic McEliece).

The integrity-protected data in signed form or in KEM-protected form can conversely also comprise a classical, non-PQ-secure digital signature, in particular RSA signature, DSA, ECDSA, or be protected by a classical, non-PQ-secure KEM mechanism. That is to say that the preceding authentication and key agreement is verified in particular by utilizing a classical digital signature method or a classical KEM mechanism, e.g. by utilizing RSA encryption. A post-quantum method is used for the preceding authentication and key agreement, on the other hand.

In some embodiments, the signature unit is designed to protect the integrity of the data by means of:
a post-quantum secure signature method or a post-quantum secure key encapsulation mechanism or
a classical cryptographic digital signature method, in particular an RSA signature method, DSA or ECDSA, thereby delivering the integrity-protected data in the signed form and/or in integrity-protected form.

In some embodiments, the data comprise:
at least one message that was exchanged within the authentication and key agreement protocol sequence, which can also be referred to as exchanged AKA messages and/or AKA protocol messages,
a message part of a message that was exchanged within the authentication and key agreement protocol sequence,
a control message in an industrial automation system that was exchanged within the authentication and key agreement protocol sequence,
a cryptographic hash value of a message that was exchanged within the authentication and key agreement protocol sequence.

In some embodiments, the data comprise multiple messages and/or multiple message parts that were exchanged within the authentication and key agreement protocol sequence. The multiple messages and/or multiple message parts may be messages and/or message parts transmitted between the first and the second subscriber in opposite transmission directions. Furthermore, the data can comprise multiple messages and/or multiple message parts that were exchanged between the first and the second subscriber within a plurality or within a multiplicity of authentication and key agreement protocol sequences. Furthermore, the data can comprise multiple messages and/or multiple message parts that were exchanged between multiple different subscribers within a plurality or within a multiplicity of authentication and key agreement protocol sequences.

In some embodiments, the data comprise a parameter of an authentication and key agreement associated with the authentication and key agreement protocol sequence, which can in particular be considered to be an AKA parameter included in messages, the parameter being in the form of:
an authentication credential of the authentication and key agreement associated with the authentication and key agreement protocol sequence,
information about a communication partner of the authentication and key agreement protocol sequence,
an identifier ID of a communication partner of the authentication and key agreement protocol sequence, and/or
user data of a communication partner of the authentication and key agreement protocol sequence.

The parameter is associated with the authentication and key agreement protocol sequence. The parameter can also be regarded as additional information derived and/or determined by means of an analysis of the authentication and key agreement protocol sequence. In particular, the parameter is in the form of said authentication credential, said information about a communication partner, said identifier ID and/or said user data of a communication partner. The parameter facilitates later content evaluation and/or review of the integrity-protected data, which can also be referred to as the AKA verification.

In some embodiments, the verification unit additionally comprises a transmission unit, designed to transmit the integrity-protected data. The integrity-protected data, which can also be referred to as the AKA verification, can be transmitted out of band or in band, i.e. outside of or within the cryptographically protected, authenticated communication session as part of the authentication and key agreement protocol sequence between a first and a second subscriber. In the case of an in-band transmission, the transmission can take place within the security protocol (e.g. TLS, IPsec) itself, e.g. in a header, or it can be transmitted using a higher-level transport protocol or application protocol based thereon (e. g. HTTP, COAP, MQTT, XMPP). An in-band transmission is appropriate in particular when the verification unit is borne by one of the communication partners of the authentication and key agreement protocol sequence. An out-of-band transmission takes place outside of the cryptographically protected, authenticated communication session between the first and the second subscriber, which session is protected by the authentication and key agreement protocol sequence. However, it can take place via the same communication network or via the same communication path, for example.

An out-of-band transmission has the advantage that the AKA verification (e.g. PQ-secure additional authentication) can be produced, can be transmitted and can be reviewed irrespective of the actual security protocol (IPsec/IKEv2, TLS, DTLS). This allows additional protection for unchanged, non-PQ-secure security protocols to be feasibly added. Such additional protection alone may be sufficient specifically when especially the integrity of the data transmission and the authenticity of the communication subscribers are supposed to be protected, e.g. when control messages are transmitted in an industrial automation system. In such cases, PQ-secure encryption (and therefore confidentiality) or even encryption of the data transmitted in cryptographically protected form is often not necessary.

In some embodiments, the verification unit additionally comprises an encryption unit, designed to deliver the integrity-protected data in encrypted form. In general, delivery of the integrity-protected data in encrypted form and/or encrypted transmission (in-band or out-of-band) has the advantage that the AKA verification undertaken with the third credential is encrypted and thus cannot be read by an attacker, which hampers attacks on the third credential (e.g. side channel attacks). The advantage of unencrypted transmission, on the other hand, is that the AKA verification can also be reproduced outside of the two subscribers if necessary and does not need to be additionally protected, which firstly can somewhat eliminate computing power and latency and secondly avoids a possibly partially guessable dataset protected with secret credentials (the latter could facilitate attacks, e.g. if a protocol weakness is discovered).

In some embodiments, the authentication and key agreement associated with the authentication and key agreement protocol sequence entails:
a classical cryptographic algorithm, in particular pertaining to a Diffie-Hellman key exchange or an elliptic curve Diffie-Hellman key exchange,
a classical cryptographic authentication method, in particular RSA signature, DSA, ECDSA,
a post-quantum secure cryptographic method, which can also be referred to as a next-generation cryptographic method, in particular a lattice- or code-based key encapsulation mechanism (KEM), in particular Kyber, FrodoKEM or Classic McEliece, or
a hybrid method (hybrid key agreement), consisting of a classical cryptographic algorithm and a post-quantum secure cryptographic method.

In some embodiments, the notarization guideline defines a stipulation under which the generation unit is designed to derive the data, the stipulation relating to:
a security protocol,
an authentication and key agreement method, and/or
an authentication credential,
each pertaining to the authentication and key agreement associated with the authentication and key agreement protocol sequence. The notarization guideline (AKA notarization policy) therefore establishes for which AKA processes an AKA verification is supposed to be formed.

In some embodiments, the notarization guideline defines a condition under which the generation unit is designed to derive the data, the condition comprising:
connection setup,
update of a session key within a connection that has already been set up (update following prior connection setup), and/or
resumption of a previously existing (prior) connection, each as part of the authentication and key agreement protocol sequence. The condition is thus also intended to be understood to be a present situation, a state between communication partners or a boundary condition.

A fixed or stipulable AKA notarization policy thus indicates whether only a complete AKA process carried out during connection setup is supposed to be captured and confirmed, or also subsequent session key updates or also re-use of an already arranged security context in the event of a session resumption.

Some embodiments of the teachings herein include a device, comprising an inventive verification unit. The verification unit can be embodied as a separate component. It can also be embodied as an additional component of a device, as in this embodiment. The device is in particular also designed to perform the authentication and key agreement protocol sequence and to act as a communication partner for another device.

Such an AKA verification can thus be issued by the first subscriber (device) and/or by the second subscriber (other device), or it can be issued by a third node (proxy node, notary node, separate component) that determines the messages or message parts exchanged between the first and the second subscriber during the authentication and key agreement, e.g. by means of network monitoring, and confirms them independently of the first and the second node.

In some embodiments, the device additionally comprises:
an agreement unit, designed to perform an authentication and key agreement, thereby generating a session key, and
a communication unit, designed to utilize the session key in the authentication and key agreement protocol sequence to protect communication (in particular with another device).

The communication comprises interchange of data. The data interchanged within the authentication and key agreement protocol sequence are therefore associated with the authentication and key agreement protocol sequence. The data comprise in particular messages or message parts, exchanged AKA messages, which can also be referred to as AKA protocol messages, and/or control messages in an industrial automation system.

Additionally, the data associated with the authentication and key agreement protocol sequence are in particular in the form of AKA parameters included in messages, a cryptographic hash value from AKA messages and/or information about the communication partners involved (in particular devices, subscribers), in particular user data of the communication partners, an identifier ID of a communication partner and/or an authentication credential used by a communication partner for authentication and key agreement.

Some examples include a method for delivering integrity-protected data, including:
capturing an authentication and key agreement protocol sequence,
deriving data from the authentication and key agreement protocol sequence by including a notarization guideline, the data being associated with the authentication and key agreement protocol sequence,
protecting the integrity of the data, thereby forming integrity-protected data, and
delivering the integrity-protected data.

The authentication and key agreement protocol sequence is preceded by an authentication and key agreement for arranging a symmetric session key between two subscribers. The symmetric session key is used to cryptographically protect user data transmitted between the subscribers as part of the authentication and key agreement protocol sequence (e.g. IPsec, TLS Record Layer, IEEE 802.1AE). The authentication and key agreement is authenticated by means of a first authentication credential (private key) of the first subscriber (device) by means of a first cryptographic algorithm related to the first authentication credential. Optionally, in the case of mutual authentication, the (first) authentication and key agreement is additionally authenticated by means of a second authentication credential (private key) of the second subscriber (other device) by means of a second cryptographic algorithm related to the second authentication credential.

Normally, the first cryptographic algorithm and the second cryptographic algorithm are identical, i.e. the first subscriber (device) and the second subscriber (other device) use the same cryptographic algorithm to authenticate themselves each time (in particular RSA (classical), ECC (classical), KEM (classical or post-quantum)).

In some embodiments, the method comprises:
performing an authentication and key agreement, thereby generating a session key, and
communicating within the authentication and key agreement protocol sequence by utilizing the session key to protect the communication (in particular with another device).

In some embodiments, the method comprises checking the integrity-protected data. The integrity-protected data (which can also be referred to as the AKA verification) can be reviewed by the first and/or by the second communication subscriber (device and/or other device). They can also be reviewed by a special monitoring node (separate component/unit) in order to detect if a non-PQ-secure, conventional authentication should be manipulated. When such a monitoring node is used, it can, in one variant of the invention, also advantageously be employed as a PO proxy if necessary: if the second subscriber is a non-PQ-capable legacy device in the same network as the monitoring node, non-PQ-secure algorithms can be used for the communication session, while the PQ-secure AKA verification of the first subscriber is checked by the monitoring node; the latter can take the review of the PQ-secure AKA verification of the first subscriber as a basis for subsequently confirming to the second subscriber (using a non-PQ-secure method) that the first subscriber has successfully authenticated itself to the monitoring node in PQ-secure fashion and the communication can be continued. This confirmation can be provided via a purely internal interface (i.e. an interface that cannot be reached from the outside) if necessary.

The AKA verification can be reviewed immediately in order e.g. to terminate (e.g. by means of a subscriber node) or disable or restrict (e.g. by means of a firewall) the relevant communication connection detected as manipulated. Furthermore, it is possible to adapt the permissions in an application protocol transmitted via the authenticated and cryptographic communication connection, depending on whether at least one valid AKA attestation, preferably a plurality of matching AKA attestations, is available for this communication session. As such, e.g. an onboarding or a certificate issue using EST/SCEP can take place only when the additional review of the AKA verification has taken place. Furthermore, permissions for device configuration using NETCONF/YANG can be adapted on the basis of the review of an AKA verification. By way of example, particularly security-critical operations such as loading or updating cryptographic keys using NETCONF/YANG to protect TSN communication can be enabled only if an AKA verification for the communication session (e.g. TLS, ssh) that exists to protect the transmission of NETCONF/YANG is available and has been reviewed.

However, it is also possible to evaluate the AKA verifications subsequently at a later time, e.g. after the communication connection between the first and second subscribers has been cleared down. An alarm can then be generated e.g. for invalid, implausible or inconsistent AKA verifications, or a certificate that was requested or delivered using an affected authenticated communication connection can be revoked, or configuration changes to a device configuration or in a database can be rolled back, i.e. logged changes made are reversed.

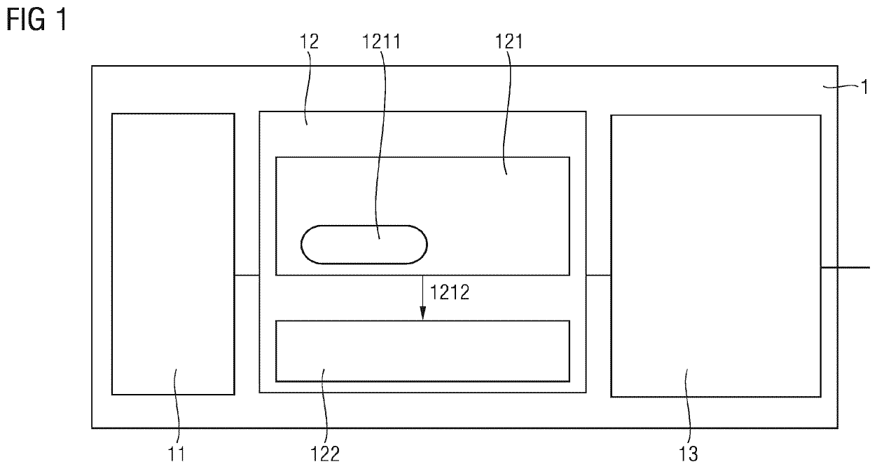

FIG. 1 shows a device 1 according to the prior art, where an application 11 (app 11) can communicate in protected fashion by means of a security protocol 12 using a communication module 13 (communication protocol 13). The security protocol 12 performs an authentication 121 and key agreement 121, which involves a session key 1212 for protecting 122 user data of the app 11 being arranged for transmission and the device 1 authenticating itself to a communication partner by means of an authentication credential 1211 (Auth-Cred 1211).

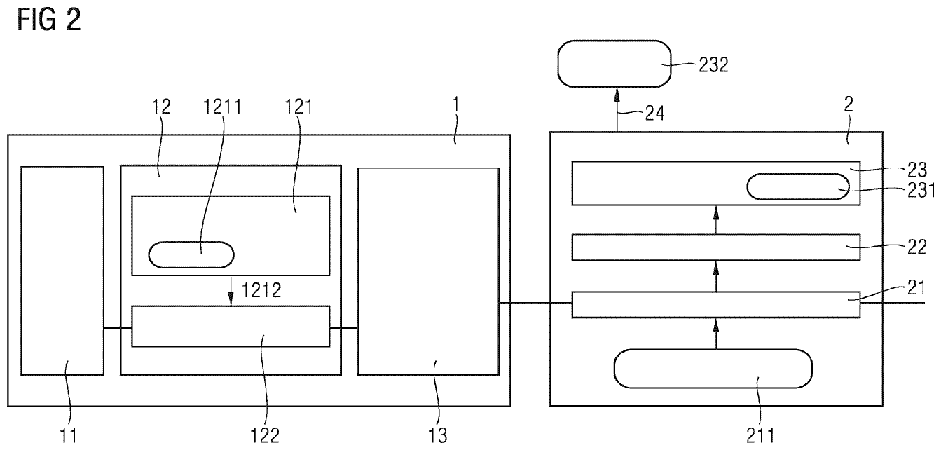

FIG. 2 shows an exemplary embodiment incorporating teachings of the present disclosure that involves a verification unit 2, as an additional component 2 (AKA notarization module 2, AKA verification system 2) to the device 1 (including the components shown in FIG. 1), forming 23 and delivering 24 a verification of an authentication and key agreement protocol sequence.

In principle, it is possible for the communication partners to authenticate themselves using a digital certificate, e.g. according to X. 509, or for them to authenticate themselves by means of a verifiable credential, or by means of a verifiable presentation. To that end, identifier of the communication partners may be stored in a distributed transaction database (distributed ledger, blockchain, e.g. Hyperledger Indy).

The relevant AKA sequences are captured by a capture unit 21 (AKA capture unit 21) in the communication protocol sequence and delivered to a generation unit 22 (the AKA notarization builder component 22), which forms the as yet unsigned AKA verification data structure comprising the AKA information to be verified (data associated with the authentication and key agreement protocol sequence).

The AKA verification data structure formed is then digitally signed by the authentication unit 23 using a verification key 231 (Notary-Cred 231). The digitally signed AKA verification 232 is delivered by the delivery unit 24. Instead of a digital signature, a KEM mechanism can also be used to protect the verification.

The AKA verification data structure can be reviewed e.g. by an AKA verification system 2 (AKA notarization module 2) or by the communication partner. On the basis of that, a signal or a message can be delivered to the communication partner so that it can adapt its functionality accordingly. Instead of a conventional digital signature, an AKA verification 232 may, in general, also be in the form of a verifiable credential or in the form of a verifiable presentation. The AKA verification unit 2 (AKA notarization module 2) can authenticate itself e.g. by means of a digital certificate, e.g. according to X.509, or by means of a decentralized identifier stored in a distributed transaction database (distributed ledger, blockchain, e.g. Hyperledger Indy).

The AKA notarization module 2 may also be integrated in the device 1 (or separate, as shown). When integrated, it may be disposed e.g. between the security protocol unit 12 and the communication module 13, or it may be integrated in the security protocol unit 12. The AKA verification 232 can also be transmitted in band, i.e. to the communication partner (e.g. as part of the user data or as part of header data of the security protocol 12 or of (0 communication protocol used for the transmission thereof).

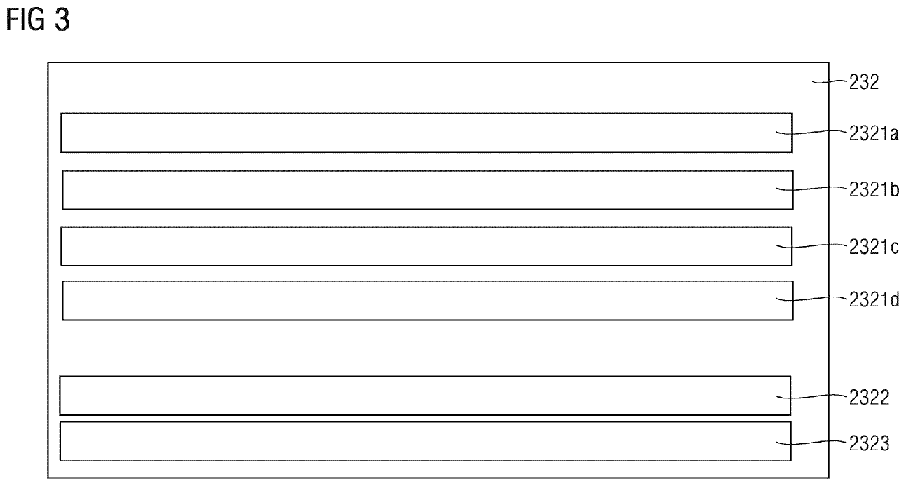

FIG. 3 shows an example of an AKA verification 232 that comprises the AKA messages (user data transmitted between the subscribers) exchanged between the communication partners during the AKA process. In the example shown, four AKA messages 2321a, 2321b, 2321c, 2321d are shown. In general, e.g. two, three, five, six or ten AKA messages 2321a, 2321b, 2321c, 2321d can also be exchanged during an AKA process. Furthermore, the AKA verification 232 comprises a time stamp 2322 and a digital signature 2323 (notary signature 2323).

Instead of the actual AKA messages 2321a, 2321b, 2321c, 2321d, just a respective cryptographic hash value for each AKA message 2321a, 2321b, 2321c, 2321d may also be included in the verification 232. Furthermore, it is possible for a hash value to be included that is formed using the exchanged AKA messages 2321a, 2321b, 2321c, 2321d of an AKA process.

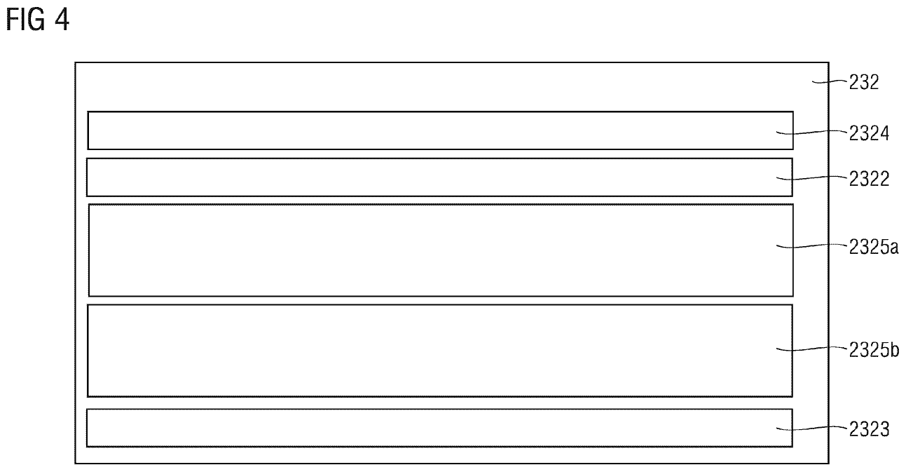

FIG. 4 shows an example of an AKA verification 232 whose content is evaluated. Besides the indication of the AKA method 2324 used (e.g. RSA, DSA, ECDSA, DH, ECDH, KEM, e.g. Kyber, FrodoKEM or Classic McEliece), said AKA verification comprises a time stamp 2322 (e.g. starting time and end time of the AKA sequence), a digital signature 2323 (notary signature 2323) and information 2325a, 2325b about the communication partners involved (their identifier IDs and the authentication credentials Auth-Cred they use).

Although the teachings herein have been illustrated and described more thoroughly in detail using the exemplary embodiments, the scope of the disclosure is not limited by the disclosed examples and other variations can be derived therefrom by a person skilled in the art without departing from the scope of protection.

What is claimed is:

1. A verification unit comprising:
a capture unit to capture an authentication and key agreement protocol sequence;
a generation unit to derive data associated with the authentication and key agreement protocol sequence from the authentication and key agreement protocol sequence by including a notarization guideline;
an authentication unit to protect the integrity of the data by forming integrity-protected data;
wherein the authentication unit comprises a signature unit to deliver the integrity-protected data in signed form,
the signature unit using:
a post-quantum secure signature method or a post-quantum secure key encapsulation mechanism or
a classical cryptographic digital signature method; and
a delivery unit to deliver the integrity-protected data.

2. The verification unit as claimed in claim 1, wherein the data comprises:
a message exchanged within the e authentication and key agreement protocol sequence;
a message part of a message exchanged within the authentication and key agreement protocol sequence;
a control message in an industrial automation system-exchanged within the authentication and key agreement protocol sequence1; or
a cryptographic hash value of a message exchanged within the authentication and key agreement protocol sequence.

3. The verification unit as claimed in claim 1,
the data comprising a parameter of an authentication and key agreement associated with the authentication and key agreement protocol sequence;
the parameter comprising:
an authentication credential of the authentication and key agreement associated with the authentication and key agreement protocol sequence;
information about a communication partner of the authentication and key agreement protocol sequence;
an identifier ID of a communication partner of the authentication and key agreement protocol sequence; and/or
user data of a communication partner of the authentication and key agreement protocol sequence.

4. The verification unit as claimed in claim 1, further comprising
a transmission unit to transmit the integrity-protected data.

5. The verification unit as claimed in claim 1, further comprising
an encryption unit to deliver the integrity-protected data in encrypted form.

6. The verification unit as claimed in claim 1, the authentication and key agreement associated with the authentication and key agreement protocol sequence entailing:
a classical cryptographic algorithm, in particular pertaining to a Diffie-Hellman key exchange or an elliptic curve Diffie-Hellman key exchange,
a classical cryptographic authentication method, in particular RSA signature, DSA, ECDSA,
a post-quantum secure cryptographic method, in particular a lattice- or code-based key encapsulation mechanism, in particular Kyber, FrodoKEM or Classic McEliece, or
a hybrid method, consisting of a classical cryptographic algorithm and a post-quantum secure cryptographic method.

7. The verification unit as claimed in claim 1, the notarization guideline defining a stipulation under which the generation unit is designed to derive the data,
the stipulation relating to:
a security protocol,
an authentication and key agreement method, and/or
an authentication credential,
each pertaining to the authentication and key agreement associated with the authentication and key agreement protocol sequence.

8. The verification unit as claimed in claim 1, the notarization guideline defining a condition under which the generation unit is designed to derive the data,
the condition comprising:
connection setup,
update of a session key within a connection that has already been set up, and/or
resumption of a previously existing connection,
each as part of the authentication and key agreement protocol sequence.

9. A device comprising:
a capture unit to capture an authentication and key agreement protocol sequence;
a generation unit to derive data associated with the authentication and key agreement protocol sequence from the authentication and key agreement protocol sequence by including a notarization guideline;
an authentication unit to protect the integrity of the data by forming integrity-protected data;
wherein the authentication unit comprises a signature unit to deliver the integrity-protected data in signed form, the signature unit using: a post-quantum secure signature method or a post-quantum secure key encapsulation mechanism or a classical cryptographic digital signature method;
a delivery unit to deliver the integrity-protected data,
an agreement unit to perform an authentication and key agreement, thereby generating session key; and
a communication unit to utilize the session key in the authentication and key agreement protocol sequence to protect communication.

10. (canceled)

11. A method for delivering integrity-protected data, the method comprising:
capturing an authentication and key agreement protocol sequence;
deriving data from the authentication and key agreement protocol sequence by including a notarization guideline the data associated with the authentication and key agreement protocol sequence;
protecting the integrity of the data, thereby forming integrity-protected data; and
delivering the integrity-protected data.

12. The method as claimed in claim 11, comprising:
performing an authentication and key agreement, thereby generating a session key; and
communicating within the authentication and key agreement protocol sequence by utilizing the session key to protect the communication.

13. The method as claimed in claim 11, further comprising
checking the integrity-protected data.
